(19) United States
(12) Patent Application Publication
(10) Pub. No.: US 2008/0065378 A1
(43) Pub. Date: Mar. 13, 2008

(54) System and method for automatic caller transcription (ACT)

(76) Inventor: James Wyatt Siminoff, Chester, NJ (US)

Correspondence Address: MILBANK, TWEED, HADLEY & MCCLOY, 1 CHASE MANHATTAN PLAZA, NEW YORK, NY, 10005-1413, US

(21) Appl. No.: 11/900,148

(22) Filed: Sep. 10, 2007

Related U.S. Application Data
(60) Provisional application No. 60/825,076, filed on Sep. 8, 2006.

(51) Int. Cl. G10L 15/26

(52) U.S. Cl. 704/235; 704/E15.043

(57) ABSTRACT

The present disclosure relates to a method for converting human voice audio in a voicemail message from a first party to a recipient into text. The method includes selecting a training file based on information identifying the first party, and converting the voicemail message into a text message using the training file.

### CROSS-REFERENCE TO RELATED APPLICATIONS

This non-provisional application claims priority to provisional application Ser. No. 60/825,076, filed Sep. 8, 2006, the entirety of which is incorporated by reference herein.

### BACKGROUND OF THE INVENTION

This invention relates to a system and method for converting audio messages, such as voicemail messages, into text messages viewable, for example, as email messages.

When converting an audio recording of the human voice into text, it may be useful have information in advance regarding certain properties of the speaker's voice and vocal patterns. For example, information relating to pitch, accent, cadence, and sentence structure may increase the accuracy of the conversion of voice to text. Therefore, it may be useful to have information regarding those characteristics for the voice to be transcribed. One way to obtain this information and increase conversion accuracy is to train the system for use with a specific human voice.

### SUMMARY OF THE INVENTION

The present disclosure relates to a method for converting human voice audio in a voicemail message from a first party to a recipient into text. The method includes selecting a training file based on information identifying the first party, and converting the voicemail message into a text message using the training file.

### BRIEF DESCRIPTION OF THE DRAWINGS

FIG. 1 is a view of an end-to-end connection showing a communication according to an aspect of the system and method of the present disclosure.

FIG. 2 is a flow chart showing one aspect of the automated transcription of voicemails by the system and method of the present disclosure.

FIG. 3 is a flow chart showing another aspect of the automated transcription of voicemails by the system and method of the present disclosure.

FIG. 4 is an example application of the system and method of the present disclosure.

### DETAILED DESCRIPTION

The system and method of the present disclosure converts audio messages, such as voicemails, to text. The system may include hardware and software for receiving, storing and transmitting voicemail messages, as well as for inputting, receiving, storing and sending text, such as email or text messages. The system may include connections to one or more various telecommunications networks.

The system and method of the present disclosure may increase transcription accuracy by “training” to the voice it is transcribing, also known as speaker dependent translation. Every human has a variation in voice and vocal patterns. Training the system for the specific human whose voice the system will convert to text may result in increased conversion accuracy. The system and method of the present disclosure may increase transcription accuracy by using a language model based on any specific information about the caller, the recipient, or from the voicemail. For example, if the voicemail is to or from a medical professional, then a language model with medical terms may be loaded to assist with the transcription. These two techniques may be used separately or in combination.

One example embodiment of the invention of the present disclosure may be as follows: A first step may include training the system based on a training-file for each individual caller voice. The training-files may be derived from stored transcripts that have been previously transcribed from voicemails from that caller. Using information from calls and/or voicemail that may be stored in a database, such as caller ID, caller telephone number, recipient telephone number, or caller's voice, the system may store, track, sort, and link all the voicemails transcribed. In one aspect, once the system has sufficient information, such as voicemails and transcriptions for a specific human voice, it may then create a training-file for that specific human voice and begin to train the system to that voice. The system may store one or more telephone numbers for each caller and may provide for multiple callers that call out using a shared number.

In one aspect, the system uses information in the database and determines whether calls and voicemails came from a telephone number shared by multiple people (such as a general office telephone number) or from non-shared telephone numbers (such as a cell phone number). Whether the telephone number is shared or non-shared may affect the threshold for determining when to begin training for a telephone number.

For a non-shared telephone number, the system may assume that there will be one caller, and may use one training file for that number. If the caller also uses other shared or non-shared telephone numbers, the training file may be used in connections with those numbers as well. For shared telephone numbers, the system may build individual training files for each caller (callers may be parsed using a variety of methods including the use of automated voice matching systems as well as human assistance) which may then be loaded and used accordingly when the shared number is the identifier.

The system and method of the present disclosure may also include automatically transcribing an incoming voicemail message. When an identifier, such as caller telephone number, of the caller is matched to a training file, the system may use the training file to transcribe the voicemail. Additionally the system may later use the transcript of the newly transcribed voicemail, for example, once some or all of the transcript has been verified as accurate by additional human or machine review, to increase the accuracy of the training file.

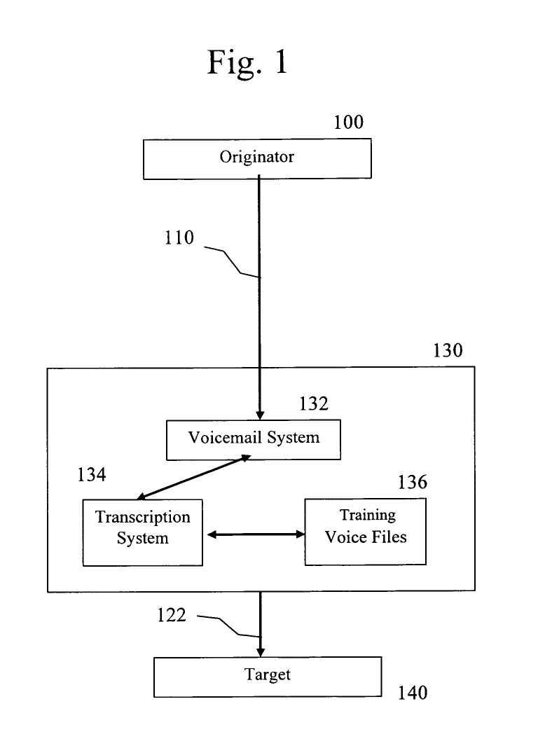

FIG. 1 illustrates aspects of the system and method of the present disclosure and includes Originator 100 which may transmit a voicemail message including audio and other data through data connection 110 to Voicemail System 132 at Center 130. The voicemail message may be sent to Transcription System 134 that may transcribe the voicemail into text. Training files 136 may contain a file containing information linking vocal sounds of a human to text words in a given language. That file may be associated with identifying information, such as the voice of the caller or other information, such as telephone numbers of the caller, Originator 100, and/or recipient, Target 122. Transcription System 134 may select the appropriate training file based upon the identifying information. Center 130 may then send a text transcription of voicemail to Target 140 via data connection 122.

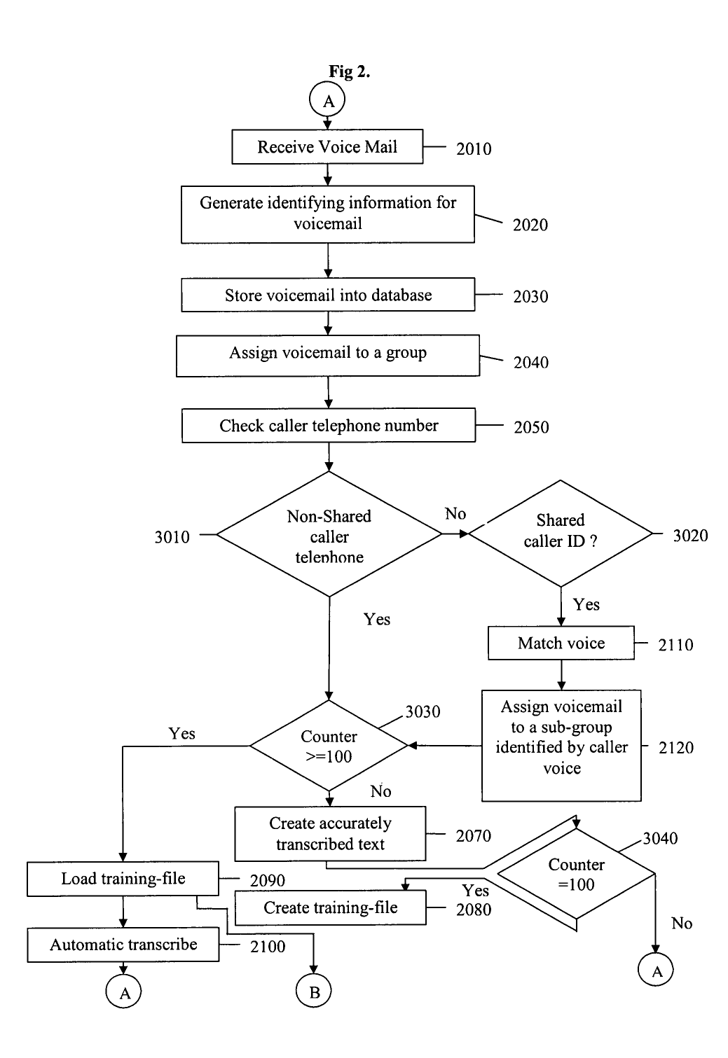

FIG. 2 is a flow chart showing how one embodiment of the current invention automatically transcribes voicemails into texts. When the system receives a voicemail in step 2010, the system may generate and store identifying information for the voicemail in step 2020. The identifying information may include the caller ID, the caller telephone number, the recipient ID, and the recipient telephone number. In step 2030, the system may store the voicemail and identifying information in a database. Voicemails in the database may be grouped according to identifying information, for example, the recipient IDs. Once the voicemail is assigned to a group in step 2040, the caller telephone number of the voicemail may be checked in step 2050. If in step 3010, the system decides that the caller telephone number is a non-shared number, the system may count the number of all the voicemails originated from that caller telephone number in step 3030. If in step 3030, the count number is smaller than a certain threshold (one hundred by way of example), then the system does not have enough voicemails from the specific caller to begin the training process and the process will flow to step 2070 where an transcribed text is created based on the voicemail. The transcribed text can be obtained through various processes, including using solely human intervention, human intervention which corrects automated output, solely automated output or any other variation or method to derive transcription. In another aspect, the system may use as a count the number of all voicemails from a caller telephone number to a specific recipient ID.

After the transcribed text has been created, the system may calculate whether it has created enough transcribed texts for the specific caller voice. Once the number of the transcribed text for one specific caller voice reaches a certain threshold (one hundred by way of example), the system may create a training-file for that specific caller voice. If in step 3030, the count number is greater than a certain threshold (one hundred by way of example), then the system has created a training-file for that specific caller voice, and the system will load the training-file in step 2090 and transcribe the voicemail into text using the training-file in step 2100.

In step 3010, if the caller telephone number is shared, then the system will go to step 3020. If the system decides that it is a shared caller telephone number in step 3020, the system will perform a voice match where voice of callers can be parsed using a variety of methods including the use of automated voice matching systems as well as human assistance. After the voice match, all the voicemails from one human voice at that shared caller telephone number may be assigned to one sub-group identified by a voice number in step 2120. Next, the system may calculates whether it has accumulated enough voicemails for that human voice in step 3030. If the number of voicemails are below one hundred, for example, the system may create a transcribed text in step 2070. Once the system has accumulated enough transcribed text (one hundred, for example) for a specific caller, a training file may be created in step 2080. If in step 3030, the system has accumulated more than one hundred voicemail for that specific person at the shared number, then the system may load the respective training file in step 2090, and transcribe the voicemail to text in step 2100.

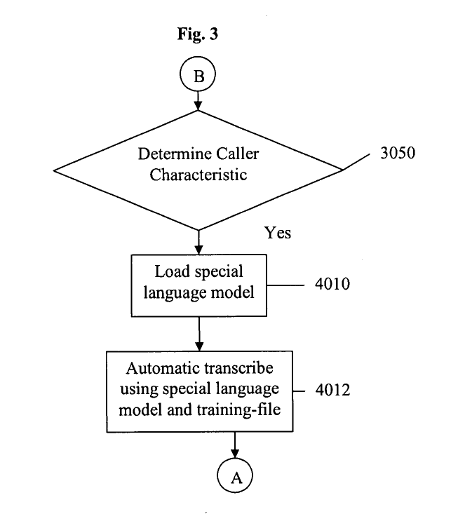

Another aspect of the system and method of the present disclosure includes using specific information, such as information from the caller and/or from the voicemail, to link a language model to increase accuracy of the transcription. For example, as shown in FIG. 3, when the system determines that the caller is a member of a specific occupation in step 3050, for example, a medical professional, the system may automatically load an occupation specific language model, in this case a medical dictionary language model, into the transcribing process in step 4010. Then the system may transcribe the voicemail using the training-file and/or the special language model to transcribe the voicemail in step 4012. Other examples of language models include models for dialects and slang, as well as occupation specific dictionary language models, such as legal and business dictionary language models.

Language models may be selected by the system based on the frequency of words used by a caller in voicemail messages, or may be selected by or at the direction of the caller, the recipient, or a system operator.

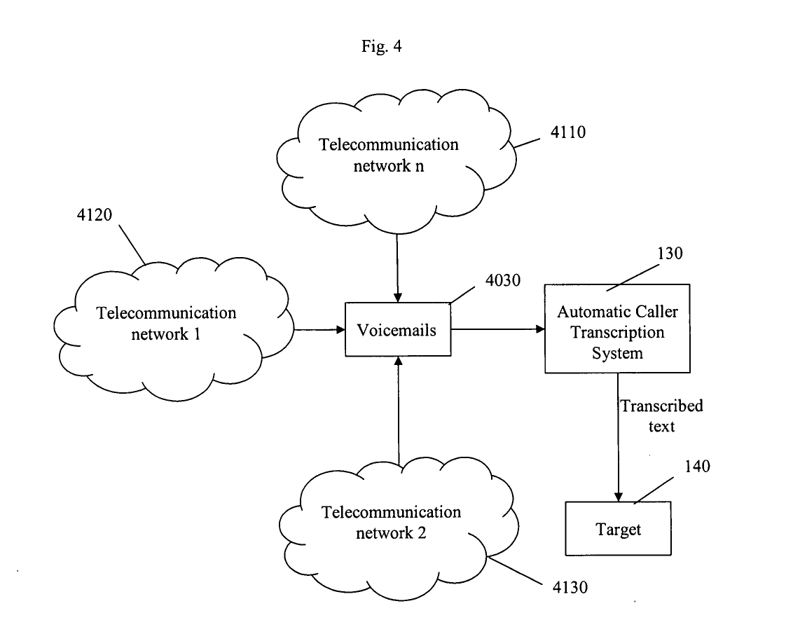

FIG. 4 is an example of an application of the system and method of the present disclosure wherein system receives voicemails from telecommunication networks and automatically transcribes the voicemail into text and forwards the text to end users.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for converting human voice audio in a voicemail message from a first party to a recipient into text, comprising:
selecting a training file based on information identifying the first party; and
converting the voicemail message into a text message using the training file.
